(19) United States
(12) Patent Application Publication
(10) Pub. No.: US 2025/0289387 A1
(43) Pub. Date: Sep. 18, 2025

(54) ELECTRIFIED VEHICLE AND METHOD OF CONTROLLING POWER MANAGEMENT MODE FOR THE SAME

(71) Applicants: Hyundai Motor Company, Seoul (KR); Kia Corporation, Seoul (KR)

(72) Inventors: Dong Su Ha, Pohang-si (KR); Joo Hyung Lee, Yongin-si (KR); Yeong Jin Chun, Seoul (KR); Jee Wook Huh, Seoul (KR)

(21) Appl. No.: 18/890,238

(22) Filed: Sep. 19, 2024

(30) Foreign Application Priority Data
Mar. 18, 2024 (KR) 10-2024-0037344

(51) Int. Cl. B60R 16/033; B60W 10/26; H04W 4/029

(52) U.S. Cl. CPC B60R 16/033; B60W 10/26; H04W 4/029

(57) ABSTRACT

The present disclosure relates to an electrified vehicle and a method of controlling a power management mode for the vehicle that allows effective provision of the power management mode for supplying power to a non-drive system while the vehicle is parked. A method may include storing location-specific execution history of a power management mode of an electrified vehicle, classifying a location in the location-specific execution history into one of a plurality of types in the location-specific execution history based on: execution frequency, of the power management mode, associated with the location, and vehicle power consumption associated with the location, outputting information related to the power management mode, based on a type of a destination and driving progress, and, based on the electrified vehicle being parked and satisfying a predetermined condition, causing the electrified vehicle to, in the power management mode, use the stored electrical energy of the traction battery.

### CROSS-REFERENCE TO RELATED APPLICATION

The present application claims priority to Korean Patent Application No. 10-2024-0037344, filed on Mar. 18, 2024, the entire contents of which is incorporated herein for all purposes by this reference.

### BACKGROUND

### Field of the Disclosure

The present disclosure relates to an electrified vehicle and a method of controlling a power management mode for the vehicle that allows effective provision of the power management mode for supplying power to a non-drive system while the vehicle is parked.

### Description of Related Art

Driven by the increasing demand for eco-friendliness, the number of electrified vehicles equipped with electric motors as their power source is on the rise in recent years. Alongside this trend, as the number of people enjoying hanging around, relaxing, and even sleeping in vehicles while the vehicles are parked is increasing, vehicles are being perceived not just as a means of transportation but as a living space. An important aspect of this perception of living space is the power supply to convenience features that enable comfortable living, such as external electronic devices as well as the air conditioner and entertainment devices mounted in the vehicle, which may be referred to as non-drive systems that are separate from the drive system necessary for the operation of the vehicle.

Electric vehicles (EVs) equipped with large-capacity traction batteries tend to have relatively more freedom in power usage while the vehicle is parked. In contrast, compared to electric vehicles, electrified vehicles equipped with low-capacity traction batteries and battery charging devices such as fuel cells or engines have constraints in power usage while the vehicle is parked. For example, when the state of charge (SOC) of the traction battery decreases by the use of power while the vehicle is parked, hybrid electric vehicles (HEVs) equipped with an engine as a means of battery charging start the engine to charge the battery, leading to issues such as environment concerns and engine durability problem due to idling as well as noise and vibration. Another example is a fuel cell electric vehicle (FCEV). Running the fuel cell stack to provide power while the vehicle is parked adversely affects the durability of the fuel cell stack due to the short running time when the battery is charged for non-driving purposes, noise and vibration issues aside.

Therefore, there is a need to develop a method of effectively supplying power to the non-drive system in electrified vehicles having auxiliary batteries while the vehicle is parked.

The matters described above as background technology are intended to provide a better understanding of the background of the present disclosure and are not to be construed as an acknowledgment that the present disclosure falls within the purview of the related art already known to those skilled in the art.

### SUMMARY

Various aspects of the present disclosure is directed to providing an electrified vehicle and a method of controlling a power management mode for the vehicle that allows effective provision of the power management mode for supplying power to a non-drive system while the vehicle is parked.

The technical objects of one or more example embodiments of the present disclosure are not limited to the technical issues described above, and other technical issues not described herein may be clearly understood by those skilled in the art from the following description.

According to one or more example embodiments of the present disclosure, a method may include: storing location-specific execution history of a power management mode of an electrified vehicle, wherein the electrified vehicle comprises a power generation device and a traction battery, wherein the power generation device is configured to use fuel to generate electrical energy, wherein the traction battery is configured to store the generated electrical energy; classifying a location in the location-specific execution history into one of a plurality of types of locations based on: an execution frequency, of the power management mode, associated with the location, and vehicle power consumption associated with the location; outputting information related to the power management mode, based on a type of a destination and driving progress; and, based on the electrified vehicle being parked and satisfying a predetermined condition, causing the electrified vehicle to, in the power management mode, use the stored electrical energy of the traction battery.

The predetermined condition may include at least one of a parking state condition or a power state condition.

The driving progress may include a pre-departure stage, a mid-trip stage, and a post-arrival stage.

The information may include an option to, while the destination is being set in the pre-departure stage, make a reservation for entering the power management mode.

The information may include an option to, in the mid-trip stage, execute, based on a driving status, the power management mode after arriving at the destination.

The driving status may include a remaining distance to the destination and the traction battery state.

The method may further include performing a charging control based on the remaining distance and the traction battery state and further based on receiving a command to execute the power management mode through the option.

The information may include an option to enter the power management mode based on the driving progress being the post-arrival stage.

Each of the plurality of types of locations may match one or more stages of driving progress.

The method may further include outputting a proposal to enter the power management mode based on unavailability of information about the destination and further based on a condition being satisfied for the proposal after the electrified vehicle is parked.

According to one or more example embodiments of the present disclosure, an electrified vehicle may include a generation device configured to generate, using fuel, electrical energy; a traction battery storing the generated electrical energy; an output device; and a controller. The controller may be configured to store location-specific execution history of a power management mode of the electrified vehicle; classify a location in the location-specific execution history into one of a plurality of types of locations based on: an execution frequency, of the power management mode, associated with the location, and vehicle power consumption, associated with the location; output, via the output device, information related to the power management mode, based on a type of a destination and driving progress; and, based on the electrified vehicle being parked and satisfying a predetermined condition, cause the electrified vehicle to, in the power management mode, use the stored electrical energy of the traction battery.

The predetermined condition may include at least one of a parking state condition or a power state condition.

The driving progress may include a pre-departure stage, a mid-trip stage, and a post-arrival stage.

The information may include an option to, while the destination is being set in the pre-departure stage, make a reservation for entering the power management mode.

The information may include an option to, in the mid-trip stage, execute, based on a driving status, the power management mode after arriving at the destination.

The driving status may include a situation may include a remaining distance to the destination and the traction battery state.

The controller may be further configured to perform a charging control based on the remaining distance and the traction battery state and further based on receiving a command to execute the power management mode through the option.

The information may include an option to enter the power management mode based on the driving progress being the post-arrival stage.

Each of the plurality of types of locations may match one or more stages of the driving progress.

The controller may be further configured to output, via the output device, a proposal to enter the power management mode based on unavailability of information about the destination and further based on the condition for the proposal after the electrified vehicle is parked being satisfied.

According to at least one embodiment of the present disclosure, the vehicle residency is enhanced through a power management mode that allows power supply to the non-drive system while the vehicle is parked.

In particular, proposals to use the mode, tailored to the power management mode use type at the destination and the driving stages, are made such that the power management mode may be provided more effectively.

The effects that can be obtained from the present disclosure are not limited to the effects mentioned above, and other effects not mentioned will be clearly understood by those skilled in the art to which the present disclosure pertains from the following description.

### BRIEF DESCRIPTION OF THE DRAWINGS

FIG. 1 shows an example of an electrified vehicle configuration applicable to embodiments.

FIG. 2 shows an example of location-specific use types of power management mode according to an embodiment.

FIG. 3 shows an example of a matching pattern between power management modes and driving progress according to an embodiment.

FIG. 4 shows an example of a process of providing a power management mode according to an embodiment.

FIG. 5 shows an example of a form in which pre-departure power management mode information is provided according to an embodiment.

FIG. 6 shows an example of a form in which pre-departure power management mode information is provided according to an embodiment.

FIG. 7 shows an example of a form in which pre-departure power management mode information is provided according to an embodiment.

FIG. 8 shows an example of a form in which pre-departure power management mode information is provided according to an embodiment.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing

### DETAILED DESCRIPTION

Hereinafter, embodiments disclosed in the present disclosure will be described in detail with reference to the accompanying drawings, but the same reference numerals will be assigned to the similar or same components regardless of drawing numbers and repetitive descriptions will be omitted. The suffixes “module” and “unit” for the components used in the following description are given or interchangeably used only to facilitate the writing of the specification, without necessarily indicating a distinct meaning or role of their own. Further, when it is determined that the specific description of the related and already known technology may obscure the essence of example embodiments disclosed herein, the specific description may be omitted. Further, it is to be understood that the accompanying drawings are only intended to facilitate understanding of the embodiments disclosed herein and are not intended to limit the technical ideas disclosed herein are not limited to the accompanying drawings and include all the modifications, equivalents, or substitutions within the spirit and technical scope of the present disclosure.

The terms including ordinal numbers such as first, second, and the like may be used to describe various components, but the components are not to be limited by the terms. The terms may only be used for the purpose of distinguishing one component from another.

It is to be understood that when a component is referred to as being “connected” or “coupled” to another component, the component may be directly connected or coupled to the another component, but other components may be interposed therebetween. In contrast, it is to be understood that no other component is interposed when a component is referred to as being “directly connected” or “directly coupled” to another component.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

In addition, a unit or a control unit included in the names such as a motor control unit (MCU), a hybrid control unit (HCU), and the like is a term widely used in the naming of control units that control specific functions of a vehicle and does not mean a generic function unit. For example, each control unit may include a communication device that communicates with other control units or sensors to control the functions for which the control unit is responsible, a memory that stores a drive system or logic instructions and input and output information, and one or more processors that perform determinations, calculations, decisions, and the like required for controlling the functions for which the control unit is responsible.

A power management mode of an electrified vehicle may provide power of the traction battery to the non-drive system while the vehicle is parked when a preset mode entry condition is satisfied. The electrified vehicle may be an electrified vehicle equipped with power generation devices that can charge traction batteries through fuel-based power generation, such as a hybrid vehicle (HEV), plug-in hybrid vehicle (PHEV), fuel cell vehicle (FCEV), or a vehicle. The HEV or PHEV may use fossil fuel, and the power generation devices may be an engine and a motor connected thereto. The FCEV may use hydrogen as a fuel, and the power generation device may be fuel electricity. However, this is for illustrative purposes only, and the rest of the description may be similarly applied to an electric vehicle (EV), aside from controlling the charging of the traction battery through the power generation device while the vehicle is driving or parked.

Further, the power management mode provides traction battery power to the non-drive system, e.g., convenience functions such as air conditioning, entertainment, seat control, etc., and a vehicle to load (V2L) power outlet while the vehicle is parked to allow the vehicle user to use vehicle energy including electrical energy stored in the traction battery during an occupancy in the vehicle while the vehicle is parked. This is intended to provide comfortable and convenient vehicle occupancy. Of course, it is possible to supply power to the in-vehicle electrical system while the conventional vehicle having an internal combustion engine is in an ignition-on state or while the electrified vehicle is drive-ready state (e.g., HHEV/EV Ready, etc.), but the difference from the ignition-on state of the internal combustion engine vehicle is that the traction battery power is used and the difference from the ready-state is that power is supplied to the non-drive system. In particular, from the perspective of mode preparation control, when the mode is determined to be entered before arriving at the destination by an occupant or by the satisfaction of a preset condition, the vehicle may drive such that the traction battery charging device charges the traction battery during driving in the power management mode. Further, from the perspective of SOC management, a typical electrified vehicle automatically activates a traction battery charging device when the SOC of the battery decreases to the vicinity of the center SOC set for efficient driving while the vehicle is parked. However, in this power management mode, the criteria for activating the charging device is set lower than the center SOC for driving, so the activation of the charging device may be suppressed. For example, in a typical hybrid vehicle, the engine starts to charge the battery while the vehicle is parked when the SOC reaches around 50% set to be the center SOC. However, in the power management mode, the engine start may be suppressed until the SOC reaches 20%.

In the following, the power management mode is referred to as a “vehicle occupancy mode” or “stay mode” as it is a feature necessary when the occupant stays in the vehicle, and the electrified vehicle providing the vehicle occupancy mode is assumed to be a hybrid vehicle (HEV). For example, the vehicle occupancy mode may be used in situations when vehicle user(s) stay inside or occupy the vehicle for an extended period of time (e.g., longer than a predetermined time) while the vehicle is parked. This is for the convenience of description only, and the present disclosure is not limited to the name or electrified vehicle.

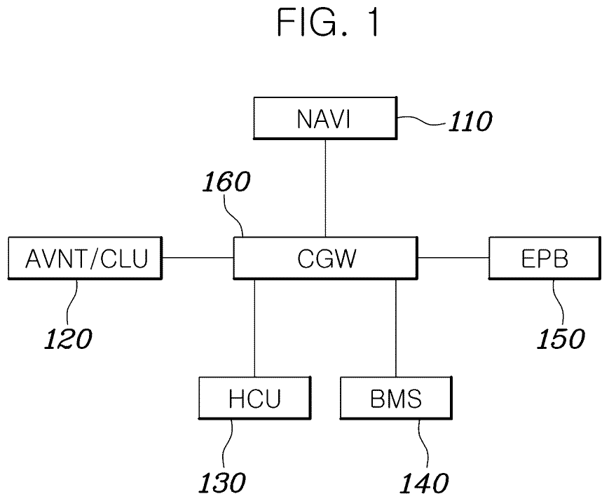

A vehicle configuration for providing a power management mode described above will be described with reference to FIG. 1 in the following.

FIG. 1 shows an example of an electrified vehicle configuration.

FIG. 1 shows that an electrified vehicle may include a navigation device 110, an audio/video/navigation/telematics (AVNT) terminal/cluster (CLU) 120, a hybrid control unit (HCU) 130, a battery management system (BMS) 140, an electronic parking brake (EPB) 150, and a center gateway (CGW) 160. Implemented electrified vehicles may include more or fewer components. Each component is described in greater detail in the following.

The navigation device 110 stores an electronic map and may provide a route guide from a current location to a specified location through destination search. In particular, the navigation system 110 may provide a destination setting function, destination-related location information providing function, remaining distance to the destination output function, etc.

The AVNT/CLU 120 provides a user interface related to the vehicle occupancy mode to enable the receipt of commands related to the vehicle occupancy mode from the occupant or the output of mode-related information. The navigation device 110 and AVNT may be implemented in a single unit. However, it is to be noted that the two devices are functionally distinct regardless of physical implementation. The navigation device 110 serves to provide the functions described above, while the AVNT/CLU 120 functions as an input device and output device in terms of interaction with the user.

The HCU 130 may function as a high-level control unit that controls the overall functions of the hybrid vehicle in an integrated manner. For example, the HCU 130 may determine the required torque based on the amount of accelerator pedal manipulation and allocate torque among the drive sources based on the driving status (e.g., driving situation) to meet the required torque. In connection with the vehicle occupancy mode, HCU 130 may determine whether a vehicle occupancy mode entry condition is satisfied, control the engagement of the EPB 150 when parking brake engagement is required, and determine the length of time the vehicle occupancy mode is available based on the battery information acquired through the BMS 140. Further, in connection with the vehicle occupancy mode, location-specific usage history of the vehicle occupancy mode may also be recorded based on the location information obtained from the navigation device 110 and the battery information of the MBS 140.

The BMS 140 may obtain and provide to the HCU 130 the state information of the traction battery (not shown) such as voltage, current, SOC, temperature, available power, etc.

The EPB 150 may determine the current state of the parking brake of the HCU 130 to engage or disengage the parking brake under its control.

The CGW 160 may perform a communication relay function between networks to which each component described above is connected.

How the vehicle occupancy mode may be provided will be described based on the aforementioned vehicle configuration in the following.

First, entry into the vehicle occupancy mode may be made when the occupant inputs a predetermined mode entry command through the AVNT/CLU 120 or when the destination at which the mode entry is reserved in advance is reached. At this time, the HCU 130 may allow entry into the vehicle occupancy mode when the preset mode entry condition is satisfied, even when the command is input or when the reserved destination is reached. The preset mode entry condition may be associated with the power state and the parking state. For example, the condition may be satisfied when the vehicle is in the HEV Ready state, the P gear is engaged, and the parking brake is engaged. However, this is for illustrative purposes only and the present disclosure is not limited thereto. For example, the mode entry condition may further include a SOC condition of the traction battery.

When entry into the vehicle occupancy mode is reserved (e.g. the vehicle occupancy mode entry option is selected at the time of destination setting or an entry reservation is selected during driving), the HCU 130 may drive the powertrain in a charge-oriented control mode that increases the SOC of the traction battery until the destination is reached. The charge-oriented control may involve methods such as increasing the center SOC of the traction battery during driving, avoiding EV mode until the target SOC set for the vehicle occupancy mode is reached, etc. However, these are for illustrative purposes only and the control methods are not limited thereto.

When the vehicle occupancy mode is entered, the HCU 130 may remain in the Ready state, but the lamp on the start button may be turned off. Further, in the vehicle occupancy mode, the HCU 130 may prohibit the operation of the drive system and supply power to the non-drive system. For example, when the transmission is implemented as a shift-by-wire (SBW), the HCU 130 may not allow gear shifting even when the occupant manipulates the shift lever. Further, the non-drive system may refer to a drive motor powered by the traction battery or to an air conditioning system, convenience system, etc. that are not directly involved in the driving of wheels among the vehicle's electrical systems. However, when the winding of the drive motor is used as an inductive component or an inverter is used to control the drive motor as a switching device when performing power conversion such as step-down in the process of supplying the traction battery power to the internal electrical system, depending on the vehicle type, using the drive system for such purposes does not involve wheel drive and thus may be treated as a non-drive system in the vehicle occupancy mode.

The vehicle occupancy mode may be deactivated by the manipulation of the start (IG) button by the driver, but this is not the only way. When the vehicle occupancy mode is deactivated, charging is performed through engine operation so that the SOC may increase again.

On the other hand, the location-specific usage patterns of the vehicle occupancy mode are learned, and based on this, preparations for entering the vehicle occupancy mode may be made or the occupant may be encouraged to use it when the destination is determined.

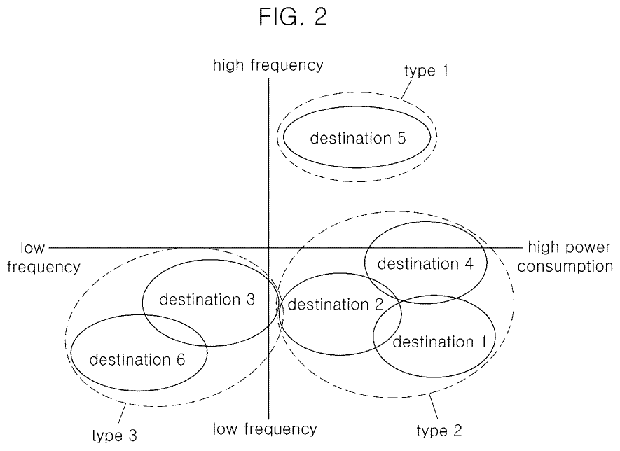

The occupant may use the vehicle occupancy mode for various reasons, such as visiting a drive-in theater, caring for young children, waiting for a pickup, watching content, resting during long-distance drive, camping, meditating, handling business, grooming, etc. These activities may be associated with specific locations, occurring whenever the vehicle is parked in particular places, or they may occur regardless of location. The power consumed while staying in the vehicle may vary depending on the activities. However, the usage pattern in the vehicle occupancy mode can be classified into a plurality of types according to the power consumption and frequency of use. This is described with reference to FIG. 2.

FIG. 2 shows an example of location-specific use types of power management mode.

FIG. 2 shows that destination 5 falls into type 1 characterized by a high entry frequency in vehicle occupancy mode and high power need (consumption). For such a type, occupants often plan on the stay situation in advance based on their lifestyle patterns or vehicle usage, and their high power consumption likely makes them aware of the need to charge the battery.

Destinations 2, 4, and 1 fall into type 2 characterized by high power need and a low mode entry frequency. Predicting is a challenge for the occupant, but the need for power preparation is high.

Next, destinations 3 and 6 fall into type 3, characterized by a low mode entry frequency and low power consumption. For such a type, the vehicle occupancy mode is needed for a short period intermittently, and occupants may not readily be aware of the usefulness of the vehicle occupancy mode, about which it may be necessary for the vehicle to prompt the occupants.

When the type of vehicle occupancy mode entry (i.e., frequency and power consumption) at each destination is cumulatively stored or learned by the HCU 130, the HCU 130 may perform type classification for each destination accordingly as shown in FIG. 2.

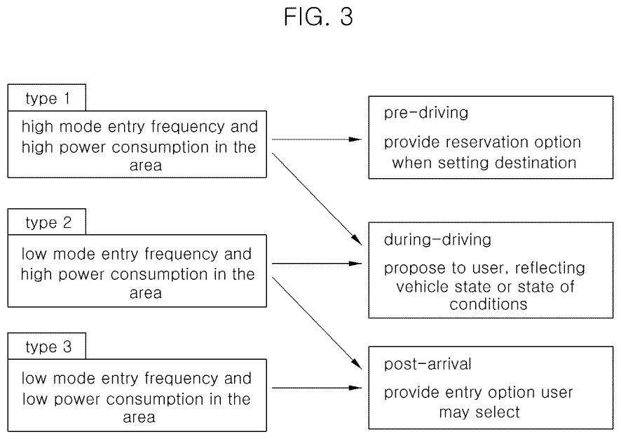

Once grouping by type is completed, the HCU 130 determines what type a destination falls into when the destination is determined and provides information related to vehicle occupancy mode differentiated by (e.g., specific to) the type of the destination and the driving progress to the destination. This is described with reference to FIG. 3.

FIG. 3 shows an example of a matching pattern between power management modes and driving progress.

FIG. 3 shows that types of vehicle occupancy mode are on the left and information provided in each driving stage is on the right. The types of vehicle occupancy mode are the same as described above with reference to FIG. 2, and the driving progress may be classified into three stages: pre-departure (e.g., pre-driving) stage, a mid-trip (e.g., during-driving) stage, and a post-arrival stage.

The information provided before departure may be a reservation option to enter the vehicle occupancy mode, the option being offered at the time of destination setting before departure. If a reservation is set at the time of destination setting, the HCU 130 may perform charge-oriented or efficiency-oriented control to ensure that the target SOC for the vehicle occupancy mode is reached upon arriving at the destination in formulating a driving strategy to the destination.

Further, the information provided during driving may include an option to check with the user whether or not to enter the vehicle occupancy mode upon arriving at the destination, reflecting the vehicle state or conditions. In particular, the option to check the entry is preferably displayed at a point where there is enough remaining distance for charging through charge-oriented control to ensure that sufficient SOC is available when the destination is reached. Therefore, the HCU 130 may consider the current SOC of the traction battery, the remaining distance to the destination, and the target SOC for vehicle occupancy mode to determine the timing of the option display. The target SOC may be determined in consideration of the minimum SOC for driving efficiency and the average power consumption when the vehicle occupancy mode is entered at the destination. This is for illustrative purposes only, and the present disclosure is not limited thereto.

In addition, the information provided after arrival may be an option for the user to select the vehicle occupancy mode entry directly.

In a relationship between type and driving progress as shown in FIG. 3, when traveling to a destination falling into type 1, an option to reserve an entry into the vehicle occupancy mode may be provided at the time of destination setting before departure and an option to confirm the entry reservation into the vehicle occupancy mode upon arriving may be provided during driving. This allows the vehicle to secure the SOC of the traction battery in advance by charge-oriented control during driving, in order to prepare for type 1 which typically requires more power consumption.

For type 2, the entry frequency is low, but there is still a need to prepare the SOC, so it is possible to inquire about the use of the vehicle occupancy mode at the destination during driving. It is also possible to inquire about the intention to enter after arrival.

For type 3, the need to secure SOC in advance is low, so the inquiry about the intention to enter the vehicle occupancy mode may be suppressed until after arrival.

Type classification according to the location-specific entry frequency in vehicle occupancy mode and power consumption as described above and differentiated output of information matching the type classification based on the driving progress allow the more effective provision of the vehicle occupancy mode function.

The types and driving progress are classified into three categories and three stages respectively in FIGS. 2 and 3. This is for illustrative purposes only, and the present disclosure is not limited thereto and may have more or fewer types or stages. Further, those skilled in the art can make various modifications to the matching relationship between types and driving progress.

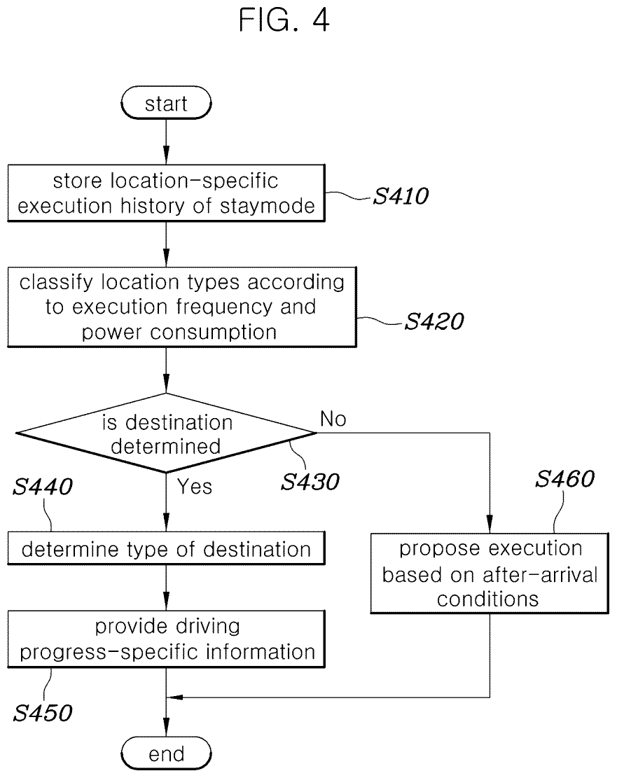

A flowchart of a vehicle occupancy mode control process described above is shown in FIG. 4.

FIG. 4 shows an example of a process of providing a power management mode.

FIG. 4 shows that the location-specific execution history of vehicle occupancy mode may first be stored in the HCU 130 (S410). Depending on the implementation, the storage location may be the navigation device 110 or AVNT 120 rather than the HCU 130. The stored history information may include whether the vehicle occupancy mode was executed at the location where the vehicle was parked and the power consumption of the traction battery when the vehicle occupancy mode was executed.

The HCU 130 may classify each of the locations into one of the plurality of types according to the execution frequency of the vehicle occupancy mode and power consumption based on the stored history.

Then, once the destination is determined (Yes in S430), the HCU 130 may determine the type of the destination based on the classification results (S440). Here, determining the destination may mean that the destination is set in the navigation device 110. This is for illustrative purposes only and the present disclosure is not limited thereto. For example, determining the destination may include scenarios where the destination is set externally via telematics services or when the destination is predicted based on learning.

Once the type of the destination is determined, the HCU 130 may provide information related to vehicle occupancy mode according to the type and driving progress through AVNT/CLU 120 (S450).

In contrast, when the destination is undetermined (No in S430) or when destination information is unavailable, the HCU 130 may assess the parking state (e.g., P gear engagement and parking brake engagement) to provide information proposing the vehicle occupancy mode execution through AVNT/CLU 120 subject to the satisfaction of the condition for the proposal (S460). Here, the proposal condition may be the doors remaining closed for a certain period, e.g., 30 seconds, after parking is detected. This is for illustrative purposes only and the present disclosure is not limited thereto. For example, the proposal condition may also include other criteria such as the SOC of the traction battery having a certain value or more.

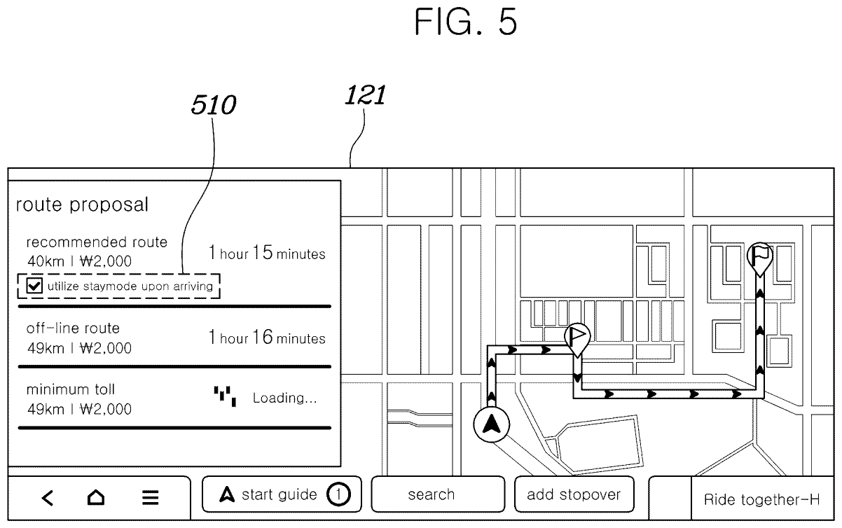

Specific examples of information related to vehicle occupancy mode provided in each scenario are described with reference to FIGS. 5 to 8.

FIG. 5 shows an example of a form in which pre-departure power management mode information is provided.

FIG. 5 shows that when pre-departure information such as the destination falling into type 1 is output, an option 510 to activate the vehicle occupancy mode upon arriving may be provided on a display 121 of the AVNT, along with a route option.

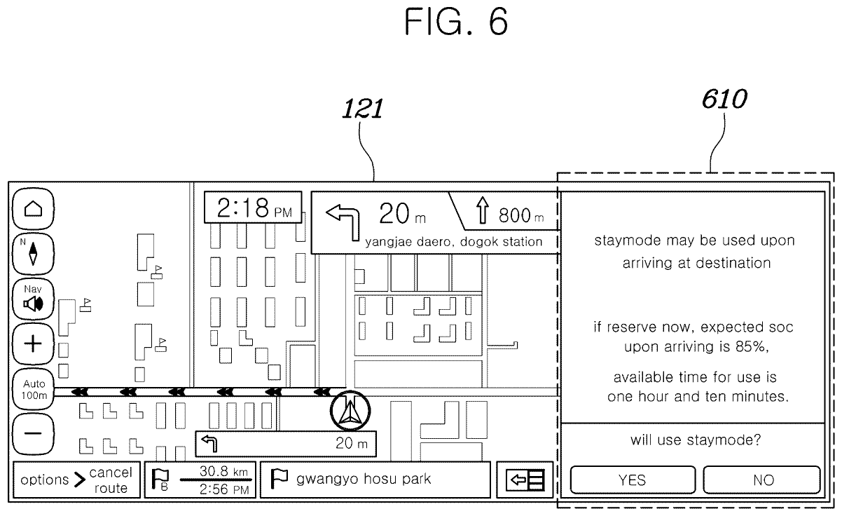

FIG. 6 shows an example of a form in which pre-departure power management mode information is provided.

FIG. 6 shows that when the destination falls into type 1 and the same pre-departure options as those in FIG. 5 are provided but not selected or when the destination falls into type 2, an option 610 to check whether or not to enter vehicle occupancy mode upon arriving at the destination may be displayed during route guidance. The option 610 may include information such as the expected SOC and expected available time for vehicle occupancy mode upon arriving when charge-oriented control is performed from the current time onwards.

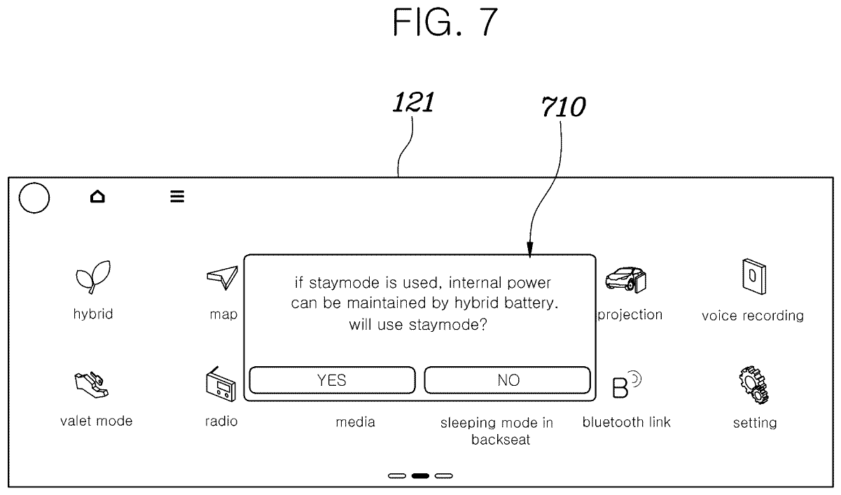

FIG. 7 shows an example of a form in which pre-departure power management mode information is provided.

FIG. 7 shows that when the destination falls into type 2 or 3, an option 710 to check whether or not to enter vehicle occupancy mode upon detecting parking such as P gear engagement after arriving at the destination may be output on the display 121 of the AVNT.

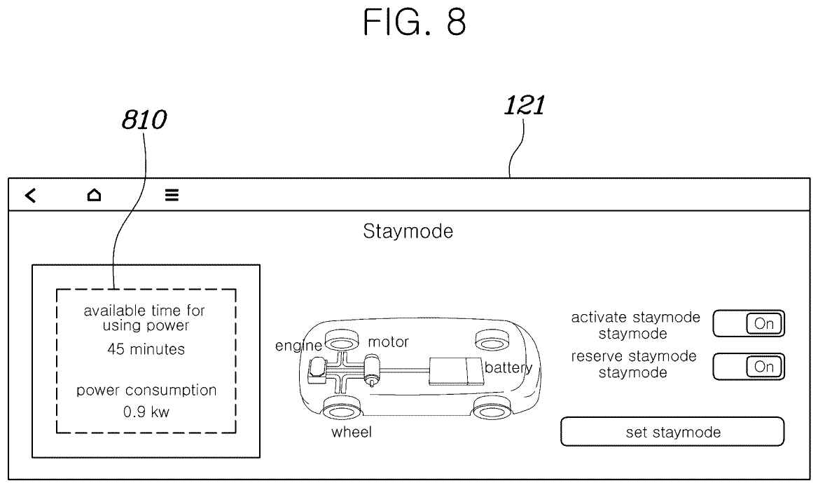

FIG. 8 shows an example of a form in which pre-departure power management mode information is provided.

FIG. 8 shows that information about the current power consumption and expected available time based on the current power consumption may be output on the display 121 of the AVNT while vehicle occupancy mode is being executed.

Differentiated information such as location-specific type grouping through learning or cumulative storage and checking whether or not to enter the mode for each driving progress may be provided. In particular, through the functions of checking whether or not to enter the vehicle occupancy mode or reserving an entry thereinto, not only is the occupant reminded of vehicle functions but also the necessary power can be secured in advance before arriving at the destination. Further, there is no need for the user to locate and select the vehicle occupancy mode entry option manually and thus the process is made convenient.

On the other hand, the present disclosure may be implemented as a computer-readable code on a medium on which a program is recorded. A computer-readable medium includes all types of recording device that stores data that can be read by a computer system. Examples of computer-readable media are a hard disk drive (HDD), a solid state disk (SSD), a silicon disk drive (SDD), ROM, RAM, CD-ROM, a magnetic tape, a floppy disk, an optical data storage device, and the like. Accordingly, the description detailed above is not to be construed in a restricted sense and is to be considered illustrative. The scope of the present disclosure is to be determined by a reasonable interpretation of the appended claims, and all modifications within the equivalent scope of the present disclosure are to be included in the scope of the present disclosure.

What is claimed is:

1. A method comprising:
storing location-specific execution history of a power management mode of an electrified vehicle, wherein the electrified vehicle comprises a power generation device and a traction battery, wherein the power generation device is configured to use fuel to generate electrical energy, wherein the traction battery is configured to store the generated electrical energy;
classifying a location in the location-specific execution history into one of a plurality of types of locations based on:
an execution frequency, of the power management mode, associated with the location, and
vehicle power consumption associated with the location;
outputting information related to the power management mode, based on a type of a destination and driving progress; and
based on the electrified vehicle being parked and satisfying a predetermined condition, causing the electrified vehicle to, in the power management mode, use the stored electrical energy of the traction battery.

2. The method of claim 1, wherein the predetermined condition comprises at least one of a parking state condition or a power state condition.

3. The method of claim 1, wherein the driving progress comprises a pre-departure stage, a mid-trip stage, and a post-arrival stage.

4. The method of claim 3, wherein the information comprises an option to, while the destination is being set in the pre-departure stage, make a reservation for entering the power management mode.

5. The method of claim 3, wherein the information comprises an option to, in the mid-trip stage, execute, based on a driving status, the power management mode after arriving at the destination.

6. The method of claim 5, wherein the driving status comprises a remaining distance to the destination and a traction battery state.

7. The method of claim 6, further comprising performing a charging control based on the remaining distance and the traction battery state and further based on receiving a command to execute the power management mode through the option.

8. The method of claim 3, wherein the information comprises an option to enter the power management mode based on the driving progress being the post-arrival stage.

9. The method of claim 1, wherein each of the plurality of types of locations matches one or more stages of the driving progress.

10. The method of claim 1, further comprising outputting a proposal to enter the power management mode based on unavailability of information about the destination and further based on a condition being satisfied for the proposal after the electrified vehicle is parked.

11. An electrified vehicle comprising:
a generation device configured to generate, using fuel, electrical energy;
a traction battery configured to store the generated electrical energy:
an output device; and
a controller configured to:
store location-specific execution history of a power management mode of the electrified vehicle;
classify a location in the location-specific execution history into one of a plurality of types of locations based on:
an execution frequency, of the power management mode, associated with the location, and
vehicle power consumption associated with the location;
output, via the output device, information related to the power management mode, based on a type of a destination and driving progress; and
based on the electrified vehicle being parked and satisfying a predetermined condition, cause the electrified vehicle to, in the power management mode, use the stored electrical energy of the traction battery.

12. The electrified vehicle of claim 11, wherein the predetermined condition comprises at least one of a parking state condition or a power state condition.

13. The electrified vehicle of claim 11, wherein the driving progress comprises a pre-departure stage, a mid-trip stage, and a post-arrival stage.

14. The electrified vehicle of claim 13, wherein the information comprises an option to, while the destination is being set in the pre-departure stage, make a reservation for entering the power management mode.

15. The electrified vehicle of claim 13, wherein the information comprises an option to, in the mid-trip stage, execute, based on a driving status, the power management mode after arriving at the destination.

16. The electrified vehicle of claim 15, wherein the driving status comprises a remaining distance to the destination and a traction battery state.

17. The electrified vehicle of claim 16, wherein the controller is further configured to perform a charging control based on the remaining distance and the traction battery state and further based on receiving a command to execute the power management mode through the option.

18. The electrified vehicle of claim 13, wherein the information comprises an option to enter the power management mode based on the driving progress being the post-arrival stage.

19. The electrified vehicle of claim 11, wherein each of the plurality of types of locations matches one or more stages of the driving progress.

20. The electrified vehicle of claim 11, wherein the controller is further configured to output, via the output device, a proposal to enter the power management mode based on unavailability of information about the destination and further based on the condition for the proposal after the electrified vehicle is parked being satisfied.
